(19) United States
(12) Patent Application Publication
(10) Pub. No.: US 2023/0103232 A1
(43) Pub. Date: Mar. 30, 2023

(54) ALL-SOLID-STATE BATTERY AND METHOD FOR MANUFACTURING SAME

(71) Applicant: Panasonic Intellectual Property Management Co., Ltd., Osaka (JP)

(72) Inventors: SHUZO TSUCHIDA, Nara (JP); AKIHIRO HORIKAWA, Osaka (JP)

(21) Appl. No.: 17/931,091

(22) Filed: Sep. 9, 2022

(30) Foreign Application Priority Data
Sep. 29, 2021 (JP) 2021-159187

(51) Int. Cl. H01M 4/62; H01M 10/0585; H01M 4/36; H01M 4/139

(52) U.S. Cl. CPC H01M 4/625; H01M 10/0585; H01M 4/366; H01M 4/139; H01M 2004/028

(57) ABSTRACT

An all-solid-state battery has a structure including a positive electrode current collector; a positive electrode layer containing a positive electrode active material, a first solid electrolyte, a second solid electrolyte, and a conductive fiber; a solid electrolyte layer containing a fourth solid electrolyte; a negative electrode layer containing a negative electrode active material and a third solid electrolyte; and a negative electrode current collector. These are stacked in this order. The positive electrode layer includes: a fiber-containing region that coats the positive electrode active material and that contains the conductive fiber and the first solid electrolyte; and a fiber-free region that is located in a gap surrounded by the positive electrode active material coated by the fiber-containing region. The fiber-free region is free of the conductive fiber, and contains the second solid electrolyte.

### BACKGROUND

### 1. Technical Field

The present disclosure relates to an all-solid-state battery and a method for manufacturing the same, and more particularly to an all-solid-state battery using a positive electrode layer, a negative electrode layer, and a solid electrolyte layer, and a method for manufacturing the same.

### 2. Description of the Related Art

In recent years, development of a secondary battery that can be repeatedly used has been required due to weight reduction, cordless extension, or the like of electronic devices such as personal computers and mobile phones. Examples of the secondary battery include a nickel-cadmium battery, a nickel hydrogen battery, a lead-acid battery, and a lithium ion battery. Among these batteries, the lithium ion battery has characteristics such as light weight, high voltage, and high energy density, and is thus attracting attention.

In a field of an automobile such as an electric vehicle or a hybrid vehicle, development of a secondary battery having a high battery capacity is regarded as important, and a demand for the lithium ion battery tends to increase.

The lithium ion battery is formed of a positive electrode layer, a negative electrode layer, and an electrolyte disposed between the positive electrode layer and the negative electrode layer, and a solid electrolyte or an electrolyte solution obtained by dissolving a supporting salt such as lithium hexafluorophosphate in an organic solvent is used for the electrolyte. Currently, a widely used lithium ion battery is combustible since an electrolytic solution containing an organic solvent is used. Therefore, a material, a structure, and a system for securing safety of the lithium ion battery are required. In cope with this, it is expected that by using a noncombustible solid electrolyte as the electrolyte, the material, the structure, and the system described above can be simplified, and it is considered that an energy density can be increased, a manufacturing cost can be reduced, and productivity can be improved. Hereinafter, a battery using a solid electrolyte such as a lithium ion battery using a solid electrolyte conducting lithium (Li) ions will be referred to as an “all-solid-state battery”.

The solid electrolyte can be roughly classified into an organic solid electrolyte and an inorganic solid electrolyte. The organic solid electrolyte has a lithium ion conductivity of about 10⁻⁶ S/cm at 25° C., the lithium ion conductivity is extremely low as compared with a lithium ion conductivity of about 10⁻³ S/cm of an electrolytic solution. Therefore, it is difficult to operate the all-solid-state battery using the organic solid electrolyte in an environment at 25° C. As the inorganic solid electrolyte, an oxide-based solid electrolyte, a sulfide-based solid electrolyte, and a halide-based solid electrolyte are generally used. Lithium ion conductivities of these solid electrolytes are about 10⁻⁴ S/cm to 10⁻³ S/cm, which are relatively high lithium ion conductivities. Therefore, in development of the all-solid-state battery directed to further increasing in size and capacity, studies of an all-solid-state battery enabling a large size and using these inorganic solid electrolytes have been actively conducted in recent years.

In addition, for a purpose of improving performance and reliability of the all-solid-state battery, addition of additives has been studied. For example, Japanese Unexamined Patent Application Publication No. 2020-507893 discloses a configuration in which an active material, a solid electrolyte layer, and a linear structure are mixed in a positive electrode layer or a negative electrode layer.

### CITATION LIST

### Patent Literature

PTL 1: Unexamined Japanese Patent Publication (Translation of PCT Application) No. 2020-507893

### SUMMARY

In order to achieve the above object, an all-solid-state battery according to an aspect of the present disclosure has a structure including a positive electrode current collector; a positive electrode layer containing a positive electrode active material, a first solid electrolyte, a second solid electrolyte, and a conductive fiber; a solid electrolyte layer containing a fourth solid electrolyte; a negative electrode layer containing a negative electrode active material and a third solid electrolyte; and a negative electrode current collector. The positive electrode current collector, the positive electrode layer, the solid electrolyte layer, the negative electrode layer, and the negative electrode current collector are stacked in this order. The positive electrode layer includes: a fiber-containing region that coats the positive electrode active material and that contains the conductive fiber and the first solid electrolyte; and a fiber-free region that is located in a gap surrounded by the positive electrode active material coated by the fiber-containing region. The fiber-free region is free of the conductive fiber, and contains the second solid electrolyte.

### BRIEF DESCRIPTION OF THE DRAWINGS

FIG. 1 is a schematic view showing a cross section of an all-solid-state battery according to an embodiment;

FIG. 2 is a schematic cross-sectional view illustrating a method for manufacturing the all-solid-state battery according to the embodiment;

FIG. 3 is a flowchart showing a method for preparing a positive electrode mixture according to the embodiment;

FIG. 4 is a flowchart showing a method for preparing a positive electrode mixture according to a comparative example;

FIG. 5A is a schematic view showing the positive electrode mixture according to the embodiment;

FIG. 5B is an enlarged schematic view showing a vicinity of a gap among positive electrode active materials in the positive electrode mixture according to the embodiment;

FIG. 6A is a schematic view showing the positive electrode mixture according to the comparative example;

FIG. 6B is an enlarged schematic view showing a vicinity of a gap among positive electrode active materials in the positive electrode mixture according to the comparative example;

FIG. 7A is an enlarged schematic view showing a vicinity of a gap among positive electrode active materials in a positive electrode layer according to the embodiment;

FIG. 7B is an enlarged schematic view showing a vicinity of a portion where the positive electrode active materials in the positive electrode layer are close to one another according to the embodiment;

FIG. 8A is an enlarged schematic view showing a vicinity of a gap among positive electrode active materials in a positive electrode layer according to the comparative example;

FIG. 8B is an enlarged schematic view showing a vicinity of a portion where the positive electrode active materials in the positive electrode layer are close to one another according to the comparative example; and

FIG. 9 shows results of evaluation for charge-discharge efficiency.

### DETAILED DESCRIPTIONS

In one method for manufacturing an all-solid-state battery disclosed in Japanese Unexamined Patent Application Publication No. 2020-507893, a positive electrode layer is formed by forming a film containing a mixture in which a positive electrode active material, solid electrolyte particles, and a linear structures (hereinafter, referred to as a conductive fiber) made of a carbon material are mixed. When the conductive fiber is contained in the positive electrode layer, a conductive path in the positive electrode layer is secured, and an improvement in battery capacity is expected. However, when the positive electrode layer containing the conductive fiber is formed, there are the following two problems.

The first problem is that, since the positive electrode active material, the solid electrolyte, and the conductive fiber is disorderly mixed, the fine conductive fiber is present in an entire region where the solid electrolyte is present inside the positive electrode layer completed as a battery. In this case, since the conductive fiber inhibits lithium ion conduction in the region where the solid electrolyte is present, the positive electrode active material is not effectively utilized, resulting in a decrease in battery capacity.

The second problem is that when the positive electrode layer is formed, the conductive fiber is entangled with the positive electrode active material and the solid electrolyte particles to increase friction resistance between the particles, thereby deteriorating dispersibility of the positive electrode active material and the solid electrolyte particles in the positive electrode layer. In this case, the positive electrode active material is not effectively utilized, resulting in a decrease in battery capacity.

The present disclosure has been made in view of the above problems, and an object of the present disclosure is to provide an all-solid-state battery or the like capable of improving a battery capacity.

Outline of Present Disclosure

An outline of an aspect of the present disclosure is as follows.

An all-solid-state battery according to an aspect of the present disclosure has a structure including a positive electrode current collector; a positive electrode layer containing a positive electrode active material, a first solid electrolyte, a second solid electrolyte, and a conductive fiber; a solid electrolyte layer containing a fourth solid electrolyte; a negative electrode layer containing a negative electrode active material and a third solid electrolyte; and a negative electrode current collector. The positive electrode current collector, the positive electrode layer, the solid electrolyte layer, the negative electrode layer, and the negative electrode current collector are stacked in this order. The positive electrode layer includes: a fiber-containing region that coats the positive electrode active material and that contains the conductive fiber and the first solid electrolyte; and a fiber-free region that is located in a gap surrounded by the positive electrode active material coated by the fiber-containing region. The fiber-free region is free of the conductive fiber, and contains the second solid electrolyte.

Accordingly, in the gap surrounded by the positive electrode active material in the positive electrode layer, the fiber-free region, which is less likely to inhibit the ion conduction due to being free of the conductive fiber and containing the second solid electrolyte, is present, so that an ion conduction path can be secured. In addition, the conductive fiber can be concentrated in the fiber-containing region present between the adjacent positive electrode active materials, so that a conductive path between the positive electrode active materials can be secured even with a small addition amount of the conductive fiber. Therefore, in the all-solid-state battery according to the present aspect, the positive electrode active material is effectively utilized, and the battery capacity can be improved.

For example, a material of the first solid electrolyte may be identical to a material of the second solid electrolyte.

Accordingly, since the material of the solid electrolyte contained in the fiber-containing region and the material of the solid electrolyte contained in the fiber-free region are unified, the ion conduction in the positive electrode layer can be made smooth.

For example, the positive electrode layer may include a plurality of regions, each of the plurality of regions may include the gap, the positive electrode active material, and the fiber-free region, and in each of the plurality of regions, a volume occupied by the fiber-free region may be 1/45 times or more and 2 times or less a volume occupied by the positive electrode active material.

Accordingly, the gap in the positive electrode active materials does not become too large in the positive electrode layer as a whole while stably securing the ion conduction path in the positive electrode layer by the fiber-free region, and thus the positive electrode active material is effectively utilized. Therefore, the battery capacity of the all-solid-state battery can be improved.

For example, the fiber-free region may continuously extend over the entire positive electrode layer in a thickness direction of the positive electrode layer.

Therefore, the ion conduction path is stably secured in the thickness direction of the entire positive electrode layer, and the battery capacity can be improved.

For example, an average fiber diameter of the conductive fiber may be 1 nm or more and 30 nm or less.

Therefore, the conductive path between the positive electrode active materials is stably formed, and the battery capacity can be improved.

For example, an average fiber length of the conductive fiber may be 0.1 times or more and 50 times or less an average particle diameter of the positive electrode active material.

Therefore, the conductive path between the positive electrode active materials is stably formed, and the battery capacity can be improved.

For example, in the positive electrode layer, a volume ratio of the positive electrode active material to a total amount of the first solid electrolyte and the second solid electrolyte may be 70:30 or more and 85:15 or less.

Accordingly, both the ion conduction path and the conductive path in the positive electrode layer are easily secured.

For example, a solvent component contained in the positive electrode layer may be 50 ppm or less.

Accordingly, since a solvent is not substantially contained in the positive electrode layer, deterioration of a material of the positive electrode layer is prevented.

For example, the conductive fiber may be a carbon-based material.

Accordingly, deterioration or the like is less likely to occur during use of the battery, and battery performance can be stabilized.

For example, a method for manufacturing the above-described all-solid-state battery, the method includes: mixing the positive electrode active material, the first solid electrolyte, and the conductive fiber by a dry method to form a coating layer on the positive electrode active material, the coating layer containing the conductive fiber and the first solid electrolyte; and mixing the positive electrode active material on which the coating layer is formed and the second solid electrolyte to apply particles free of the conductive fiber and containing the second solid electrolyte to the coating layer.

Accordingly, in the coating layer forming step, the coating layer to be the fiber-containing region can be formed by only mixing the materials by the dry method. In addition, by mixing the second solid electrolyte after the coating layer is formed, a positive electrode mixture in which the second solid electrolyte is applied to the coating layer is prepared. By using such a positive electrode mixture, the positive electrode layer including the fiber-containing region and the fiber-free region can be easily formed.

Hereinafter, an all-solid-state battery according to an embodiment will be described in detail. Each embodiment to be described below shows a general or specific example. Numerical values, shapes, materials, constituent elements, arrangement positions and connection forms of the constituent elements, steps, processes, and the like described in the following embodiments are examples, and are not intended to limit the present disclosure. Further, among the constituent elements in the following embodiments, constituent elements not recited in any one of the independent claims are described as optional constituent elements.

In addition, in the present specification, terms indicating relationships between elements such as parallel, terms indicating shapes of elements such as rectangles, and numerical value ranges are not expressions expressing only strict meanings, and are expressions that mean substantially equivalent ranges, for example, differences of about several percent.

Each drawing is a schematic view that is appropriately emphasized, omitted, or adjusted in proportion to show the present disclosure, is not necessarily exactly illustrated, and may differ from an actual shape, positional relationship, and ratio. In the drawings, substantially the same components are denoted by the same reference numerals, and redundant description may be omitted or simplified.

Further, in the present specification, terms “up” and “down” in a configuration of the all-solid-state battery do not refer to an upward direction (vertically upward direction) and a downward direction (vertically downward direction) in absolute space recognition, and are used as terms that are defined by a relative positional relationship between materials or terms that are defined by a relative positional relationship based on a stacking order in a stacked configuration.

In the present specification, a cross-sectional view is a view showing a cross section in a case where a central portion of the all-solid-state battery is cut in a stacking direction.

### Embodiments

Configuration

A configuration of an all-solid-state battery according to the present embodiment will be described.

A. All-Solid-State Battery

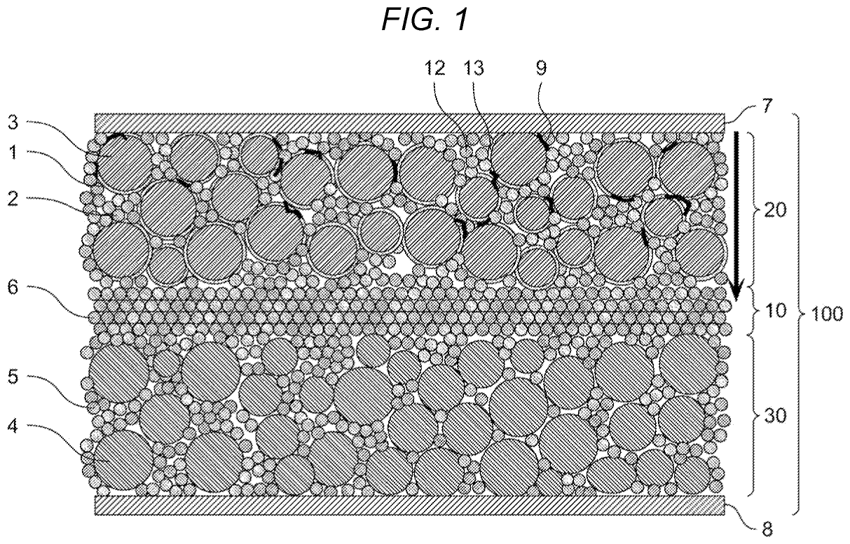

First, an overview of the all-solid-state battery according to the present embodiment will be described with reference to FIG. 1. FIG. 1 is a schematic view showing a cross section of all-solid-state battery 100 according to the present embodiment. All-solid-state battery 100 according to the present embodiment includes positive electrode current collector 7, negative electrode current collector 8, positive electrode layer 20 formed on a surface of positive electrode current collector 7 close to negative electrode current collector 8 and containing positive electrode active material 3, first solid electrolyte 1, second solid electrolyte 2 and conductive fiber 9, negative electrode layer 30 formed on a surface of negative electrode current collector 8 close to positive electrode current collector 7 and containing negative electrode active material 4 and third solid electrolyte 5, and solid electrolyte layer 10 disposed between positive electrode layer 20 and negative electrode layer 30 and containing fourth solid electrolyte 6. In other words, all-solid-state battery 100 has a structure in which positive electrode current collector 7, positive electrode layer 20, solid electrolyte layer 10, negative electrode layer 30, and negative electrode current collector 8 are stacked in this order.

Positive electrode layer 20 includes fiber-containing region 13 and fiber-free region 12. Fiber-containing region 13 is positioned so as to coat at least a part of a surface of positive electrode active material 3, and contains first solid electrolyte 1 and conductive fiber 9. In fiber-containing region 13, conductive fiber 9 is embedded in first solid electrolyte 1. Fiber-containing region 13 contains, for example, first solid electrolyte 1 and conductive fiber 9. Fiber-free region 12 is positioned in a gap among positive electrode active materials 3 coated with fiber-containing region 13, is free of a conductive fiber such as conductive fiber 9, and contains second solid electrolyte 2. It can also be said that fiber-free region 12 is positioned so as to coat fiber-containing region 13 from a side of fiber-containing region 13 opposite to a positive electrode active material 3 side. Fiber-free region 12 contains, for example, second solid electrolyte 2, or second solid electrolyte 2 and a binder. In addition, fiber-free regions 12 are connected along the gaps among positive electrode active materials 3 in a stacking direction of the all-solid-state battery, in other words, in a thickness direction of positive electrode layer 20 (an arrow direction in FIG. 1). In addition, fiber-free regions 12 are connected so as to straddle positive electrode layer 20 in the thickness direction of positive electrode layer 20. That is, fiber-free regions 12 are connected along the thickness direction of positive electrode layer 20, and connected fiber-free regions 12 extend from one end to the other end in the thickness direction of positive electrode layer 20. Therefore, an ion conduction path by fiber-free regions 12 is stably secured in the entire thickness direction of positive electrode layer 20, and the battery capacity can be improved.

All-solid-state battery 100 according to the present embodiment is formed by, for example, the following method. Positive electrode layer 20 formed on positive electrode current collector 7 made of a metal foil, negative electrode layer 30 formed on negative electrode current collector 8 made of a metal foil, and solid electrolyte layer 10 disposed between positive electrode layer 20 and negative electrode layer 30 are formed. Then, pressing is performed from outer sides of positive electrode current collector 7 and negative electrode current collector 8 to obtain all-solid-state battery 100. A pressing pressure is, for example, 100 MPa or more and 1000 MPa or less, and by the pressing, a one-layer filling rate of at least one of solid electrolyte layer 10, positive electrode layer 20, and negative electrode layer 30 is 60% or more and less than 100%. A detailed method for manufacturing all-solid-state battery 100 will be described later.

By setting the filling rate to 60% or more, since the amount of voids is reduced in solid electrolyte layer 10, positive electrode layer 20, or negative electrode layer 30, ion conduction and electron conduction are often performed, and good charge-discharge characteristics can be obtained. The filling rate is a ratio of a volume occupied by materials and excluding voids between the materials to a total volume.

Pressed all-solid-state battery 100 is attached to, for example, a terminal and is accommodated in a case. As the case for all-solid-state battery 100, for example, a case made of stainless steel (SUS), iron, or aluminum, a case made of a resin, or an aluminum laminate bag is used.

Hereinafter, details of solid electrolyte layer 10, positive electrode layer 20, and negative electrode layer 30 in all-solid-state battery 100 according to the present embodiment will be described.

B. Solid Electrolyte Layer

First, solid electrolyte layer 10 will be described. Solid electrolyte layer 10 according to the present embodiment contains fourth solid electrolyte 6, and may further contain a binder.

B-1. Fourth Solid Electrolyte

Fourth solid electrolyte 6 according to the present embodiment will be described. Examples of a solid electrolyte material used for fourth solid electrolyte 6 include an inorganic solid electrolyte such as a sulfide-based solid electrolyte, a halide-based solid electrolyte, and an oxide-based solid electrolyte, which are generally known materials. The solid electrolyte material has, for example, lithium ion conductivity. As the solid electrolyte material, any of the sulfide-based solid electrolyte, the halide-based solid electrolyte, and the oxide-based solid electrolyte may be used. A type of the sulfide-based solid electrolyte according to the present embodiment is not particularly limited. Examples of the sulfide-based solid electrolyte include Li₂S—SiS₂, LiI—U₂S—SiS₂, LiI—Li₂S—P₂S₅, LiI—Li₂S—P₂O₅, LiI—Li₃PO₄—P₂S₅, and Li₂S—P₂S₅. In particular, from a viewpoint of excellent lithium ion conductivity, the sulfide-based solid electrolyte may contain Li, P, and S. Further, since reactivity with the binder is high and bondability to the binder is high, the sulfide-based solid electrolyte may contain P₂S₅. The above description of “Li₂S—P₂S₅” means a sulfide-based solid electrolyte formed by using a raw material composition containing Li₂S and P₂S₅, and the same applies to other descriptions.

In the present embodiment, the sulfide-based solid electrolyte material described above is, for example, a sulfide-based glass ceramic containing Li₂S and P₂S₅, and with respect to a ratio of Li₂S to P₂S₅, Li₂S:P₂S₅ in terms of molars may be in a range of 70:30 or more and 80:20 or less, or in a range of 75:25 or more and 80:20 or less. By setting the ratio of Li₂S to P₂S₅ within the above ranges, a crystal structure having high lithium ion conductivity can be obtained while maintaining a Li concentration that influences battery characteristics. Further, by setting the ratio of Li₂S to P₂S₅ within the above ranges, an amount of P₂S₅ for reacting with and binding to the binder is likely to be secured.

Fourth solid electrolyte 6 contains, for example, a plurality of particles.

An average particle diameter of fourth solid electrolyte 6 is smaller than, for example, an average particle diameter of positive electrode active material 3. Accordingly, a contact surface with positive electrode active material 3 in positive electrode layer 20 can be sufficiently secured.

The average particle diameter of fourth solid electrolyte 6 is, for example, 0.2 μm or more and 10 μm or less. Accordingly, it is possible to prevent a decrease in lithium ion conductivity of entire solid electrolyte layer 10 by reducing particle interfaces in solid electrolyte layer 10 and reducing resistance components in the particle interfaces while sufficiently securing the contact surface with positive electrode active material 3 in positive electrode layer 20.

B-2. Binder

The binder according to the present embodiment will be described. The binder is an adhesive material that does not have lithium ion conductivity and electron conductivity, and plays a role of bonding the materials in solid electrolyte layer 10 to one another and bonding solid electrolyte layer 10 to other layers. The binder according to the present embodiment may contain a thermoplastic elastomer into which a functional group for improving adhesion strength is introduced, the functional group may be a carbonyl group, and from a viewpoint of improving the adhesion strength, the carbonyl group may be maleic anhydride. Oxygen atoms in the maleic anhydride react with fourth solid electrolyte 6 to bond fourth solid electrolytes 6 to one another via the binder, thereby forming a structure in which the binder is disposed between fourth solid electrolyte 6 and fourth solid electrolyte 6. As a result, the adhesion strength is improved.

Examples of the thermoplastic elastomer include styrene-butadiene-styrene (SBS) and styrene-ethylene-butadiene-styrene (SEBS). This is because these materials have high adhesion strength and have high durability even in cycling characteristics of the battery. As the thermoplastic elastomer, a hydrogenation-added (hereinafter, referred to as hydrogenated) thermoplastic elastomer may be used. By using the hydrogenated thermoplastic elastomer, the reactivity and the bondability are improved, and solubility in a solvent used when solid electrolyte layer 10 is formed is improved.

An addition amount of the binder is, for example, 0.01 mass % or more and 5 mass % or less, may be 0.1 mass % or more and 3 mass % or less, and may be 0.1 mass % or more and 1 mass % or less. When the addition amount of the binder is set to 0.01 mass % or more, bonding via the binder is likely to occur, and sufficient adhesion strength is likely to be obtained. In addition, when the addition amount of the binder is set to 5 mass % or less, a decrease in battery characteristics such as charge-discharge characteristics is less likely to occur, and even when physical property values such as hardness, tensile strength, and tensile elongation of the binder are changed in, for example, a low temperature region, the charge-discharge characteristics are less likely to decrease.

C. Positive Electrode Layer

Next, positive electrode layer 20 according to the present embodiment will be described. Positive electrode layer 20 according to the present embodiment contains first solid electrolyte 1, second solid electrolyte 2, positive electrode active material 3, and conductive fiber 9. If necessary, a binder and a non-fibrous conductive auxiliary agent such as acetylene black and Ketjen black (registered trademark) for securing the electron conductivity may be further added to positive electrode layer 20. However, when an addition amount thereof is large, battery performance is influenced, and thus it is desirable that the addition amount is small to an extent that the battery performance is not influenced.

A weight ratio of positive electrode active material 3 to a total amount of first solid electrolyte 1 and second solid electrolyte 2 is, for example, in a range of 50:50 or more and 95:5 or less, and may be in a range of 70:30 or more and 90:10 or less.

A volume ratio of positive electrode active material 3 to the total amount of first solid electrolyte 1 and second solid electrolyte 2 is 60:40 or more and 90:10 or less, and may be 70:30 or more and 85:15 or less. With this volume ratio, both a lithium ion conduction path and a conductive path (in other words, a conduction path of electrons) in positive electrode layer 20 are easily secured.

Positive electrode current collector 7 is made of, for example, a metal foil. As the metal foil, for example, a metal foil made of SUS, aluminum, nickel, titanium, or copper is used.

C-1. First Solid Electrolyte and Second Solid Electrolyte

The solid electrolyte material used for each of first solid electrolyte 1 and second solid electrolyte 2 is freely selected from, for example, at least one or more of the solid electrolyte materials listed in the above B-1. Fourth Solid Electrolyte. In addition, the selection of the materials is not particularly limited, and a combination of the materials is selected within a range that does not significantly impair the lithium ion conductivity at, for example, an interface where positive electrode active material 3 and first solid electrolyte 1 are in contact with each other, and at an interface where first solid electrolyte 1 is in contact with each of second solid electrolyte 2 and fourth solid electrolyte 6.

Each of first solid electrolyte 1 and second solid electrolyte 2 contains, for example, a plurality of particles.

C-2. Binder

Since the binder is the same as the binder described above, the description thereof will be omitted.

C-3. Positive Electrode Active Material

Positive electrode active material 3 according to the present embodiment will be described. As a material of positive electrode active material 3 according to the present embodiment, for example, a lithium-containing transition metal oxide is used. Examples of the lithium-containing transition metal oxide include LiCoO₂, LiNiO₂, LiMn₂O₄, LiCoPO₄, LiNiPO₄, LiFePO₄, LiMnPO₄, and a compound obtained by substituting a transition metal of the above compounds with one or two different elements. Known materials such as LiNi_{1/3}Co_{1/3}Mn_{1/3}O₂, LiNi_{0.8}Co_{0.15}Al_{0.05}O₂, and LiNi_{0.5}Mn_{1.5}O₂ are used as the compound obtained by substituting the transition metal of the above compounds with one or two different elements. The materials of positive electrode active material 3 may be used alone or in combination of two or more thereof.

Positive electrode active material 3 contains, for example, a plurality of particles. The particles of positive electrode active material 3 are granulated particles in which a plurality of primary particles made of the above material are aggregated. In the present specification, these granulated particles are referred to as the particles of positive electrode active material 3.

The average particle diameter of positive electrode active material 3 is not particularly limited, and is, for example, 1 μm or more and 10 μm or less. In addition, a particle diameter distribution of positive electrode active material 3 is a distribution in which 80% or more of all the particles are present, for example, within a particle diameter of ±30% with respect to the average particle diameter. An average particle volume described later refers to a volume of a sphere assuming a sphere having the average particle diameter.

C-4. Conductive Fiber

Conductive fiber 9 according to the present embodiment is not particularly limited as long as conductive fiber 9 is a material that has conductivity, hardly reacts with positive electrode active material 3, first solid electrolyte 1, and second solid electrolyte 2, and can withstand potentials in a battery. From a viewpoint of stability of the materials during use of the battery, conductive fiber 9 is, for example, a carbon-based material. Specifically, the carbon-based material is a fibrous conductive carbon material, and examples of the carbon-based material include carbon nanotube (CNT). As the carbon nanotube, materials having various known structures such as a single wall carbon nano tube (SWCNT) and a multi wall carbon nano tube (MWCNT) are used.

D. Negative Electrode Layer

Next, negative electrode layer 30 according to the present embodiment will be described. Negative electrode layer 30 according to the present embodiment contains third solid electrolyte 5 and negative electrode active material 4. If necessary, a binder and a conductive auxiliary agent such as acetylene black and Ketjen black for securing the electron conductivity may be further added to negative electrode layer 30. However, when an addition amount thereof is large, the battery performance is influenced, and thus it is desirable that the addition amount is small to an extent that the battery performance is not influenced. With respect to a ratio of third solid electrolyte 5 to negative electrode active material 4, solid electrolyte:negative electrode active material in terms of weight is, for example, in a range of 5:95 or more and 60:40 or less, and may be in a range of 30:70 or more and 50:50 or less. In addition, a volume ratio of negative electrode active material 4 to a total volume of negative electrode active material 4 and third solid electrolyte 5 is, for example, 60% or more and 80% or less. With this volume ratio, both a lithium ion conduction path and a conductive path in negative electrode layer 30 are likely to be secured.

Negative electrode current collector 8 is made of, for example, a metal foil. As the metal foil, for example, a metal foil made of SUS, copper, or nickel is used.

D-1. Third Solid Electrolyte

The solid electrolyte material used for third solid electrolyte 5 is not particularly limited, and is freely selected from, for example, at least one or more of the solid electrolyte materials listed in the above B-1. Fourth Solid Electrolyte. Third solid electrolyte 5 contains, for example, a plurality of particles.

D-2. Binder Since the binder is the same as the binder described above, the description thereof will be omitted.

D-3. Negative Electrode Active Material

Negative electrode active material 4 according to the present embodiment will be described. As a material of negative electrode active material 4 according to the present embodiment, for example, known materials such as lithium, an easily alloyed metal with lithium such as indium, tin, and silicon, a carbon material such as hard carbon and graphite, or Li₄Ti₅O₁₂ and SiO), are used.

Negative electrode active material 4 contains, for example, a plurality of particles. An average particle diameter of negative electrode active material 4 is not particularly limited, and is, for example, 1 μm or more and 15 μm or less.

Method for Manufacturing All-Solid-State Battery

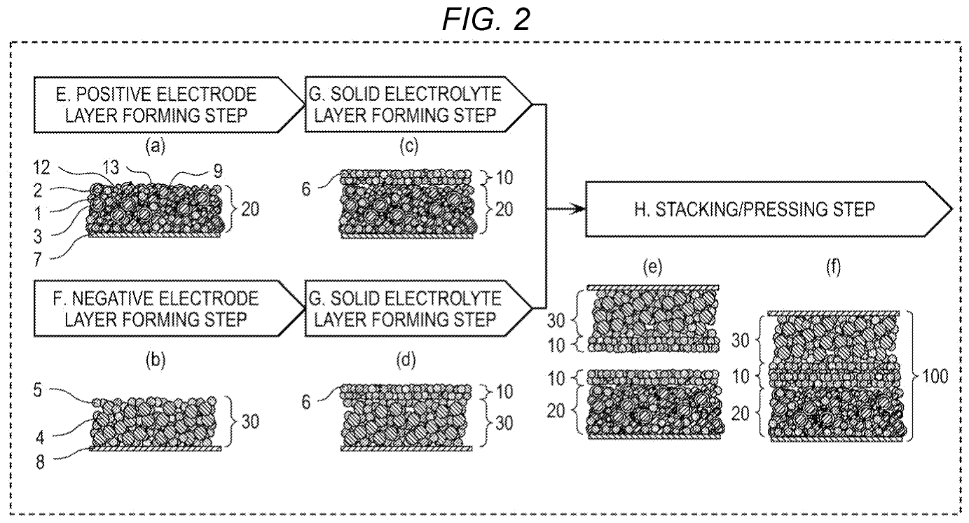

Next, a method for manufacturing all-solid-state battery 100 according to the present embodiment will be described with reference to FIG. 2. Specifically, the method for manufacturing all-solid-state battery 100 including solid electrolyte layer 10, positive electrode layer 20, and negative electrode layer 30 will be described. FIG. 2 is a schematic cross-sectional view illustrating the method for manufacturing all-solid-state battery 100.

The method for manufacturing all-solid-state battery 100 includes, for example, a positive electrode layer forming step, a negative electrode layer forming step, a solid electrolyte layer forming step, a stacking step, and a pressing step. In the positive electrode layer forming step ((a) in FIG. 2), positive electrode layer 20 is formed on positive electrode current collector 7. In the negative electrode layer forming step ((b) in FIG. 2), negative electrode layer 30 is formed on negative electrode current collector 8. In the solid electrolyte layer forming step ((c) and (d) in FIG. 2), solid electrolyte layer 10 is prepared. In the stacking step and the pressing step ((e) and (f) in FIG. 2), positive electrode layer 20 formed on positive electrode current collector 7, negative electrode layer 30 formed on negative electrode current collector 8, and prepared solid electrolyte layer 10 are stacked together such that solid electrolyte layer 10 is disposed between positive electrode layer 20 and negative electrode layer 30, and the pressing is performed from the outer sides of positive electrode current collector 7 and negative electrode current collector 8. Hereinafter, each step will be described in detail.

E. Positive Electrode Layer Forming Step

Examples of a step of forming positive electrode layer 20 (positive electrode layer forming step) according to the present embodiment include the following two methods of method (1) and method (2).

(1) Examples of a method for forming positive electrode layer 20 according to the present embodiment include a method for manufacturing positive electrode layer 20 by a forming step including a mixture adjusting step, a coating step, and a coating film pressing step. Specifically, first, in the mixture adjusting step, positive electrode active material 3, first solid electrolyte 1, and conductive fiber 9 are stirred and mixed by a dry method to perform preparation, the obtained mixed powder and second solid electrolyte 2 are dispersed in an organic solvent, and if necessary, the binder and the non-fibrous conductive auxiliary agent (not shown) are further dispersed in the organic solvent to prepare a slurry positive electrode mixture. Then, in the coating step, the surface of positive electrode current collector 7 is coated with the obtained positive electrode mixture, and the obtained coating film is dried and/or fired in order to remove the organic solvent by heating. In the coating film pressing step, the dried coating film formed on positive electrode current collector 7 is pressed. With such a forming step, positive electrode layer 20 is prepared.

A slurry coating method is not particularly limited, and examples thereof include known coating methods such as a blade coater, a gravure coater, a dip coater, a reverse coater, a roll knife coater, a wire bar coater, a slot die coater, an air knife coater, a curtain coater, an extrusion coater, and a combination thereof.

Examples of the organic solvent used for the slurry include heptane, xylene, and toluene, but the organic solvent is not limited thereto, and a solvent that does not cause a chemical reaction with positive electrode active material 3, first solid electrolyte 1, second solid electrolyte 2, and the like may be appropriately selected.

In the drying and/or firing, the method thereof is not particularly limited as long as the organic solvent can be removed by drying the coating film, and a known drying method or firing method using a heater or the like may be adopted. The dried coating film pressing method is not particularly limited, and a known pressing step using a press machine or the like may be adopted.

(2) Examples of another method for forming positive electrode layer 20 according to the present embodiment include a method in which positive electrode layer 20 is manufactured by a forming step including a mixture adjusting step, a powder stacking step, and a powder pressing step. In the mixture adjusting step, first solid electrolyte 1 in a powder state (not slurry), positive electrode active material 3, and conductive fiber 9 are stirred and mixed by the dry method to perform preparation, and the obtained mixed powder, second solid electrolyte 2, and, if necessary, the binder and the non-fibrous conductive auxiliary agent (not shown) are mixed in the powder state to prepare the positive electrode mixture. In the powder stacking step, the obtained positive electrode mixture in the powder state is uniformly stacked on positive electrode current collector 7 to obtain a stacked body. In the powder pressing step, the stacked body obtained in the powder stacking step is pressed to form a film.

When positive electrode layer 20 is manufactured in a manner of stacking the positive electrode mixture in the powder state, there is an advantage that a drying step is not necessary, so that a manufacturing cost is reduced, and the solvent resulting in a decrease in battery performance of all-solid-state battery 100 does not remain in positive electrode layer 20 after positive electrode layer 20 is formed. In addition, since the solvent is not present even in a manufacturing process, deterioration of the materials due to the solvent does not occur. Therefore, the battery performance can be improved. When all-solid-state battery 100 is manufactured in the manner of stacking the positive electrode mixture in the powder state, for example, a solvent component contained in positive electrode layer 20 is 50 ppm or less, and positive electrode layer 20 substantially does not contain the solvent component.

Here, in both the above methods (1) and (2), it is important to perform the step of stirring and mixing positive electrode active material 3, first solid electrolyte 1, and conductive fiber 9 by the dry method in the preparation of the positive electrode mixture. Here, the stirring and mixing refers to a method of mixing positive electrode active material 3, first solid electrolyte 1, and conductive fiber 9 while applying a compressive force and a shear force, and is not particularly limited to other method. The purpose of this stirring and mixing step is to form a coating layer containing first solid electrolyte 1 and conductive fiber 9 on at least a part of a surface of positive electrode active material 3. In the formation of positive electrode layer 20, a region containing conductive fiber 9 and first solid electrolyte 1 derived from the coating layer becomes fiber-containing region 13.

Next, the solid electrolyte particles formed of second solid electrolyte 2 are applied to the coating layer. In order to apply the solid electrolyte particles formed of second solid electrolyte 2, in the above method (1), for example, the particles formed of positive electrode active material 3 having the coating layer containing conductive fiber 9 formed on the surface thereof and the particles formed of second solid electrolyte 2 are dispersed in the organic solvent. In the above method (2), for example, the particles formed of positive electrode active material 3 having the coating layer containing conductive fiber 9 formed on the surface thereof and the particles formed of second solid electrolyte 2 are mixed in a dry state.

In the formation of positive electrode layer 20, a region derived from second solid electrolyte 2 and free of conductive fiber 9 becomes fiber-free region 12. A specific method for preparing the positive electrode mixture will be described later.

F. Negative Electrode Layer Forming Step The step of forming negative electrode layer 30 (negative electrode layer forming step) according to the present embodiment is the same as the step of forming positive electrode layer 20 described in the above E. Positive Electrode Layer Forming Step in the basic forming method except that a material to be used is changed to a material for negative electrode layer 30. The negative electrode layer forming step does not include, for example, the stirring and mixing step.

A method for manufacturing negative electrode layer 30 may be, for example, a method of applying a slurry negative electrode mixture obtained by mixing third solid electrolyte 5, negative electrode active material 4, and, if necessary, the binder and the conductive auxiliary agent (not shown) on negative electrode current collector 8 and then drying the slurry negative electrode mixture (that is, the same method as the method (1) in

E. Positive Electrode Layer Forming Step). In addition, the method for manufacturing negative electrode layer 30 may be, for example, a method of stacking the negative electrode mixture in a powder state which is not slurry on negative electrode current collector 8 (that is, the same method as the method (2) in E. Positive Electrode Layer Forming Step).

When negative electrode layer 30 is manufactured by the method of stacking the negative electrode mixture in the powder state, there is an advantage that the drying step is not necessary, so that the manufacturing cost is reduced, and the solvent influencing a capacity of the all-solid-state battery does not remain in negative electrode layer 30 after negative electrode layer 30 is formed.

G. Solid Electrolyte Layer Forming Step

Solid electrolyte layer 10 according to the present embodiment can be prepared by, for example, the same method as that of the above E. Positive Electrode Layer Forming Step except that, as shown in (c) and (d) of FIG. 2, the slurry is prepared by dispersing fourth solid electrolyte 6 and, if necessary, the binder in the organic solvent, and the obtained slurry is coated onto positive electrode layer 20 and/or negative electrode layer 30 prepared as described above. The solid electrolyte layer forming step does not include, for example, the stirring and mixing step.

In an example shown in (c) and (d) of FIG. 2, solid electrolyte layer 10 is formed on both positive electrode layer 20 and negative electrode layer 30, but the present disclosure is not limited thereto, and solid electrolyte layer 10 may be formed on either positive electrode layer 20 or negative electrode layer 30. In addition, solid electrolyte layer 10 may be prepared on a substrate such as a polyethylene terephthalate (PET) film by the above method, and obtained solid electrolyte layer 10 may be stacked on positive electrode layer 20 and/or negative electrode layer 30.

H. Stacking Step and Pressing Step

In the stacking step and the pressing step, positive electrode layer 20 formed on positive electrode current collector 7, negative electrode layer 30 formed on negative electrode current collector 8, and solid electrolyte layer 10, which are obtained by the respective forming steps, are stacked such that solid electrolyte layer 10 is disposed between positive electrode layer 20 and negative electrode layer 30 (stacking step), and then the pressing is performed from the outer sides of positive electrode current collector 7 and negative electrode current collector 8 (pressing step), thereby obtaining all-solid-state battery 100.

The purpose of the pressing is to increase densities of positive electrode layer 20, negative electrode layer 30, and solid electrolyte layer 10. By increasing the densities, the lithium ion conductivity and the electron conductivity can be improved in positive electrode layer 20, negative electrode layer 30, and solid electrolyte layer 10, and all-solid-state battery 100 having good battery characteristics can be obtained.

Method for Manufacturing Positive Electrode Layer

Hereinafter, detailed examples of the method for manufacturing positive electrode layer 20 of all-solid-state battery 100 according to the present embodiment will be described, but the present disclosure is not limited to these manufacturing method examples. Unless otherwise specified, each step is performed in a glove box in which a dew point is controlled to −45° C. or lower, or in a dry room.

First, a material used for positive electrode layer 20 will be described. In the manufacturing of positive electrode layer 20, for example, the positive electrode mixture containing positive electrode active material 3, first solid electrolyte 1, second solid electrolyte 2, and conductive fiber 9 is used.

Positive electrode active material 3 is selected from, for example, the materials listed in C-3. Positive Electrode Active Material in the configuration of the all-solid-state battery according to the present embodiment described above. Each of first solid electrolyte 1 and second solid electrolyte 2 is selected from, for example, the solid electrolyte materials listed in B-1. Fourth Solid Electrolyte. For example, the material of first solid electrolyte 1 is the same as that of second solid electrolyte 2. Accordingly, since the solid electrolyte material contained in fiber-containing region 13 and the solid electrolyte material contained in fiber-free region 12 are unified, the ion conduction in positive electrode layer 20 can be made smooth. Conductive fiber 9 is selected from, for example, the materials listed in C-4. Conductive Fiber. The material of first solid electrolyte 1 may be different from that of second solid electrolyte 2.

Further, the materials to be used will be described in detail. As the positive electrode active material 3, for example, a material having an average particle diameter of 5.5 μm and containing 80% or more of all particles having a particle diameter in a range of ±30% of the average particle diameter is used. For each of first solid electrolyte 1 and second solid electrolyte 2, for example, a particulate material having an average particle diameter of 0.5 μm or more and 1.0 μm or less is used. As the conductive fiber 9, a single wall carbon nano tube (SWCNT) having an average fiber diameter of 10 nm or more and 100 nm or less and an average fiber length of 1 μm or more and 100 μm or less is used.

Here, amounts of first solid electrolyte 1 and second solid electrolyte 2 used in positive electrode layer 20 are appropriately selected such that a mixing ratio of positive electrode active material 3 to all solid electrolytes, which is the total amount of first solid electrolyte 1 and second solid electrolyte 2, is within a predetermined range. The mixing ratio of positive electrode active material 3 to all solid electrolytes, which is the total amount of first solid electrolyte 1 and second solid electrolyte 2, is, for example, 70:30 or more and 85:15 or less in terms of a volume ratio, and 70:30 or more and 90:10 or less in terms of a weight ratio. Accordingly, both the ion conduction path and the conductive path in positive electrode layer 20 are easily secured.

A mixing ratio of first solid electrolyte 1 to second solid electrolyte 2 is appropriately selected within a range of the mixing ratio of positive electrode active material 3 to all solid electrolytes. The mixing ratio of first solid electrolyte 1 to second solid electrolyte 2 is, for example, 20:80 or more and 90:10 or less in terms of a volume ratio or a weight ratio. Accordingly, both the ion conduction path and the conductive path in positive electrode layer 20 are easily further secured. The mixing ratio of first solid electrolyte 1 to second solid electrolyte 2 is 25:75 or more and 87:13 or less in terms of a volume ratio or a weight ratio.

An amount of conductive fiber 9 is, for example, 0.05 mass % or more and 1 mass % or less with respect to a total amount of positive electrode active material 3, first solid electrolyte 1, and second solid electrolyte 2.

What is important in the manufacturing of positive electrode layer 20 is, for example, that conductive fiber 9 present in positive electrode layer 20 is disposed only in a vicinity of the surface of positive electrode active material 3 in finally formed positive electrode layer 20 by preparing the positive electrode mixture by the stirring and mixing step as described above. That is, it is important to form positive electrode layer 20 having a configuration in which fiber-containing region 13 containing conductive fiber 9 and first solid electrolyte 1 is present so as to coat the surface of positive electrode active material 3, and fiber-free region 12 free of conductive fiber 9 is present on fiber-containing region 13.

A method for manufacturing positive electrode layer 20, such as a mixing procedure in the preparation of the positive electrode mixture, will be described in detail below while comparing the embodiment with a comparative example.

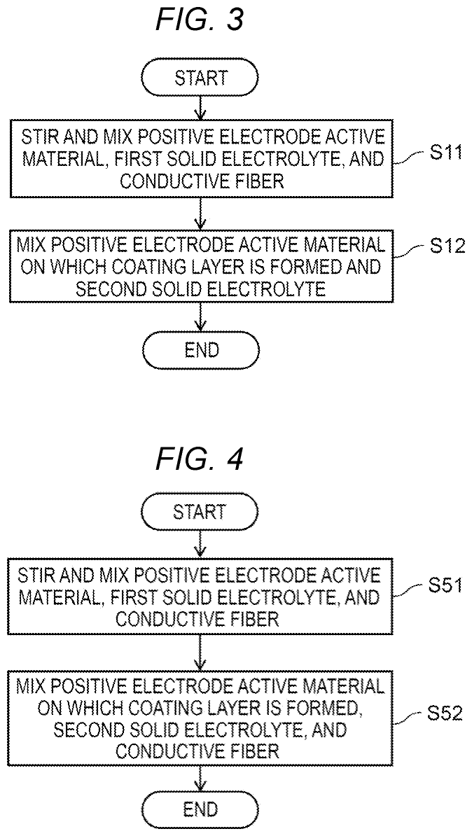

(I) Method for Preparing Positive Electrode Mixture According to Embodiment First, the method for preparing the positive electrode mixture according to the present embodiment will be described. The method for manufacturing all-solid-state battery 100 according to the present embodiment includes a coating layer forming step and a particle applying step as the steps of preparing the positive electrode mixture in the manufacturing of positive electrode layer 20. That is, the mixture adjusting step described above includes the coating layer forming step and the particle applying step. FIG. 3 is a flowchart showing the method for preparing the positive electrode mixture according to the embodiment.

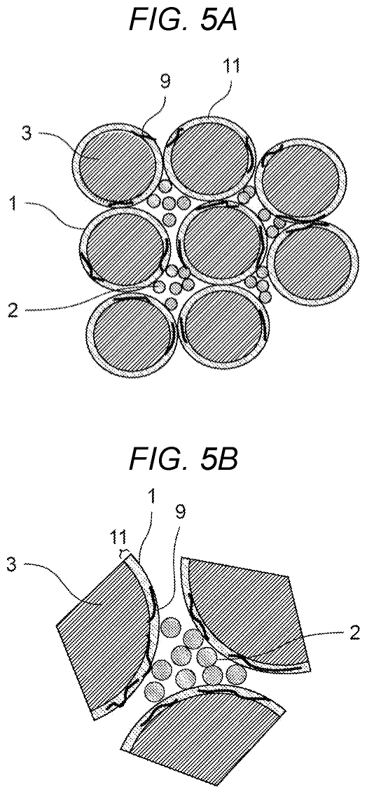

First, as the coating layer forming step, positive electrode active material 3, first solid electrolyte 1, and conductive fiber 9 are stirred and mixed by a dry method (step S11). Specifically, positive electrode active material 3, first solid electrolyte 1, and conductive fiber 9 are charged into a stirring and mixing device, and are stirred and mixed by the stirring and mixing device. As the stirring and mixing device, for example, a device in which a rotary vane for stirring and mixing is provided in a container into which the materials are charged is used. Here, the stirring and mixing is mixing in which a compressive force and a shear force are applied to the materials. For example, a predetermined space is provided between an inner wall of the container of the stirring and mixing device and the rotary vane, and the compressive force and the shear force are applied to the materials in the space by rotation of the rotary vane. The stirring and mixing in the coating layer forming step is not limited to the stirring and mixing performed by using the stirring and mixing device described above, and may be mixing in which the compressive force and the shear force are applied to positive electrode active material 3, first solid electrolyte 1, and conductive fiber 9. Accordingly, coating layer 11 (see FIG. 5B described later) containing first solid electrolyte 1 and conductive fiber 9 is formed on positive electrode active material 3.

Next, in the particle applying step, positive electrode active material 3 having coating layer 11 containing first solid electrolyte 1 and conductive fiber 9 formed on the surface thereof, and second solid electrolyte 2 are mixed (step S12). Here, the mixing refers to that positive electrode active material 3 having coating layer 11 formed on the surface thereof and second solid electrolyte 2 are treated so as to be mixed with each other as a whole. Therefore, in the particle applying step, substantially no compressive force or shear force is applied to positive electrode active material 3 on which coating layer 11 is formed and second solid electrolyte 2. As the mixing method, a known powder mixing method can be used. Accordingly, a positive electrode mixture in which particles containing second solid electrolyte 2 and free of conductive fiber 9 are applied on coating layer 11 is prepared. In the positive electrode mixture, by applying the particles containing second solid electrolyte 2, the particles containing second solid electrolyte 2 adhere to a surface of coating layer 11 formed on positive electrode active material 3. In the particle applying step, substantially no compressive force or shear force is applied to positive electrode active material 3 on which coating layer 11 is formed and second solid electrolyte 2, and thus a particle shape of second solid electrolyte 2 is maintained.

Then, positive electrode layer 20 is formed by the method (2) described in the above E. Positive Electrode Layer Forming Step by using the prepared positive electrode mixture. By using this positive electrode layer 20, all-solid-state battery 100 is manufactured by the above-described method.

(II) Method for Preparing Positive Electrode Mixture According to Comparative Example

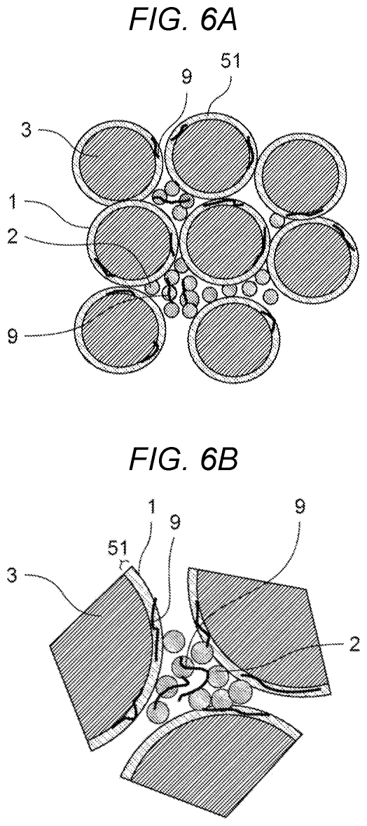

Next, a method for preparing a positive electrode mixture according to a comparative example will be described. FIG. 4 is a flowchart showing the method for preparing the positive electrode mixture according to the comparative example. First, positive electrode active material 3, first solid electrolyte 1, and conductive fiber 9 are stirred and mixed by a dry method (step S51). In step S51, the same operation as in step S11 described above is performed. Contents of the treatment expressed as the stirring and mixing is the same as that described in step S11. Accordingly, coating layer 51 (see FIG. 6B described later) containing first solid electrolyte 1 and conductive fiber 9 is formed on positive electrode active material 3.

Next, positive electrode active material 3 having coating layer 51 containing first solid electrolyte 1 and conductive fiber 9 formed on the surface thereof, second solid electrolyte 2, and conductive fiber 9 are mixed (step S52). In step S52, the same treatment as step S12 described above is performed except that conductive fiber 9 is added to the mixed material. Contents of the treatment expressed as the mixing is the same as that described in step S12. Accordingly, a positive electrode mixture in which particles containing second solid electrolyte 2 and conductive fiber 9 are present between positive electrode active materials 3 on which coating layer 51 is formed is prepared.

Then, positive electrode layer 20 is formed by the method (2) described in the above positive electrode layer forming step by using the prepared positive electrode mixture.

(III) Structures of Positive Electrode Mixture and Positive Electrode Layer

Next, structures of the positive electrode mixtures prepared by the methods for preparing the positive electrode mixture according to the embodiment and the comparative example and a structure of positive electrode layer 20 formed by using the prepared positive electrode mixture will be described.

First, the structure of the positive electrode mixture will be described. FIG. 5A is a schematic view showing the positive electrode mixture according to the embodiment. FIG. 5B is an enlarged schematic view showing a vicinity of a gap among the positive electrode active materials in the positive electrode mixture according to the embodiment. FIG. 6A is a schematic view showing the positive electrode mixture according to the comparative example. FIG. 6B is an enlarged schematic view showing a vicinity of a gap among the positive electrode active materials in the positive electrode mixture according to the comparative example.

As shown in FIG. 5A and FIG. 5B, in the positive electrode mixture according to the present embodiment, coating layer 11 containing first solid electrolyte 1 and conductive fiber 9 is formed on at least a part of the surface of positive electrode active material 3. Coating layer 11 contains, for example, first solid electrolyte 1 and conductive fiber 9. Coating layer 11 is a layer in which a layer obtained by compacting fine particles made of first solid electrolyte 1 serves as a base material. The particles of first solid electrolyte 1 are pulverized in the stirring and mixing, and the fine particles formed by the pulverization are deposited on positive electrode active material 3 while entangling conductive fiber 9, so that coating layer 11 is formed. Coating layer 11 may be in a film-like state to an extent that a shape of the fine particles formed by partial pulverization cannot be confirmed. As described above, since first solid electrolyte 1 is pulverized by being stirred and mixed, an average particle diameter of first solid electrolyte 1 is smaller than an average particle diameter of second solid electrolyte 2 to be added later.

In the positive electrode mixture, the particles made of second solid electrolyte 2 are applied on coating layer 11. In other words, the particles made of second solid electrolyte 2 adhere to the surface of coating layer 11. In the positive electrode mixture according to the present embodiment, since conductive fiber 9 is not present in the gap among positive electrode active materials 3 on which coating layer 11 is formed, the particles containing second solid electrolyte 2 are less likely to aggregate, and dispersibility between positive electrode active material 3 and second solid electrolyte 2 is improved.

As shown in FIG. 6A and FIG. 6B, in the positive electrode mixture according to the comparative example, coating layer 51 containing first solid electrolyte 1 and conductive fiber 9 same as above is formed on at least a part of the surface of positive electrode active material 3.

In addition, second solid electrolyte 2 in which conductive fiber 9 is entangled is applied to the gap among positive electrode active materials 3 on which coating layer 51 is formed. In this manner, conductive fiber 9 is entangled in second solid electrolyte 2, so that the particles of second solid electrolyte 2 are aggregated. As a result, dispersibility of positive electrode active material 3 and second solid electrolyte 2 is likely to be deteriorated as compared with the positive electrode mixture according to the embodiment.

In addition, in the positive electrode mixture according to the comparative example, conductive fiber 9 is also present in the gap among positive electrode active materials 3. Therefore, when the amount of conductive fiber 9 in the positive electrode mixture according to the embodiment is the same as the amount of conductive fiber 9 in the positive electrode mixture according to the comparative example, the amount of conductive fiber 9 in coating layer 51 according to the comparative example is smaller than the amount of conductive fiber 9 in coating layer 11 according to the embodiment.

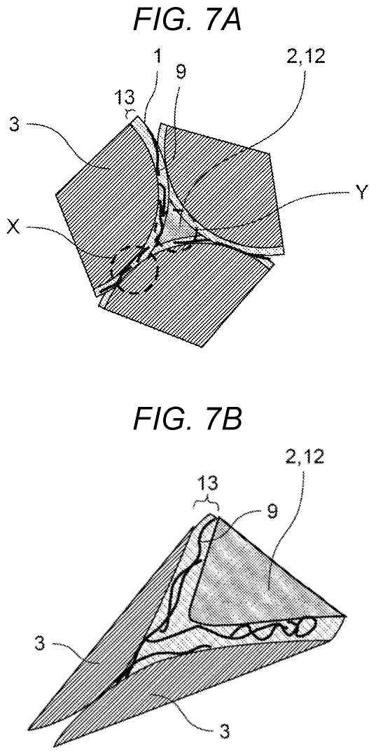

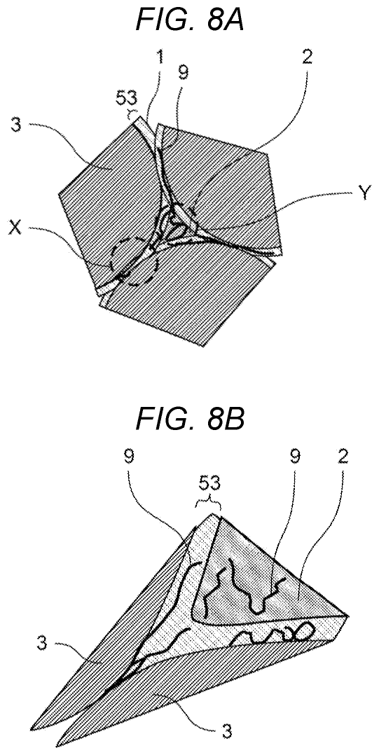

Next, the structure of the positive electrode layer formed by using the above-described positive electrode mixture will be described. FIG. 7A is an enlarged schematic view showing a vicinity of a gap among the positive electrode active materials in the positive electrode layer according to the embodiment. FIG. 7B is an enlarged schematic view showing a vicinity of a portion where the positive electrode active materials in the positive electrode layer are close to one another according to the embodiment. FIG. 8A is an enlarged schematic view showing a vicinity of a gap among the positive electrode active materials in the positive electrode layer according to the comparative example. FIG. 8B is an enlarged schematic view showing a vicinity of a portion where the positive electrode active materials in the positive electrode layer are close to one another according to the comparative example. FIGS. 7A to 8B show a state of the positive electrode layer after the above powder pressing step.

In positive electrode layer 20 formed by using the positive electrode mixture according to the present embodiment, as shown in FIG. 7A and FIG. 7B, in a gap among positive electrode active materials 3 (for example, in a vicinity of a portion Y surrounded by a broken line in FIG. 7A), fiber-free region 12 in a state in which no conductive fiber 9 is present in second solid electrolyte 2 filling the gap among positive electrode active materials 3 is formed. Accordingly, in fiber-free region 12, lithium ion conduction in second solid electrolyte 2 is not inhibited by conductive fiber 9, and thus the lithium ion conduction path can be stably secured in positive electrode layer 20. At least a part of fiber-free region 12 is formed, for example, in a region surrounded by three or more positive electrode active materials 3.

In addition, in a region where positive electrode active materials 3 are close to or in contact with one another (for example, in a vicinity of a portion X surrounded by a broken line in FIG. 7A), since coating layer 11 is formed on positive electrode active material 3, fiber-containing region 13 containing first solid electrolyte 1 and conductive fiber 9 is formed. Since fiber-containing region 13 containing conductive fiber 9 is present on positive electrode active material 3, the conductive path is secured. In addition, when the amount of conductive fiber 9 in the positive electrode mixture according to the embodiment is the same as the amount of conductive fiber 9 in the positive electrode mixture according to the comparative example, since fiber-containing region 13 derived from coating layer 11 having a larger number of conductive fiber 9 than that of coating layer 51 according to the comparative example is formed, the conductive path is more stably secured.

In positive electrode layer 20 formed by using the positive electrode mixture according to the comparative example, as shown in FIG. 8A and FIG. 8B, in a gap among positive electrode active materials 3 (for example, in a vicinity of a portion Y surrounded by a broken line in FIG. 8A), conductive fiber 9 is present in second solid electrolyte 2 filling the gap among positive electrode active materials 3. Therefore, the lithium ion conduction in second solid electrolyte 2 is inhibited by conductive fiber 9.

In addition, in a region where positive electrode active materials 3 are close to or in contact with one another (for example, in a vicinity of a portion X surrounded by a broken line in FIG. 8A), since coating layer 51 is formed on positive electrode active material 3, fiber-containing region 53 containing second solid electrolyte 2 and conductive fiber 9 is formed. Since fiber-containing region 53 containing conductive fiber 9 is present on positive electrode active material 3, the conductive path is secured. However, when the amount of conductive fiber 9 in the positive electrode mixture according to the embodiment is the same as the amount of conductive fiber 9 in the positive electrode mixture according to the comparative example, since the number of conductive fibers 9 in fiber-containing region 53 is reduced, the number of the conductive paths is also reduced.

As described above, by forming positive electrode layer 20 using the positive electrode mixture according to the embodiment, the dispersibility of positive electrode active material 3 and second solid electrolyte 2 in positive electrode layer 20 is improved, and the lithium ion conduction path and the conductive path are stably secured, as compared with the comparative example. Therefore, it is possible to obtain all-solid-state battery 100 that exhibits a high battery capacity.

### Examples

Next, results of evaluating the battery characteristics of the all-solid-state battery according to the present disclosure in Examples will be described, but the present disclosure is not limited to Examples. Specifically, all-solid-state batteries according to Example 1 and Comparative Example 1 were prepared, and battery characteristics of the prepared all-solid-state batteries were evaluated.

Preparation of All-Solid-State Battery

### (I) Example 1

A positive electrode layer was formed by using the positive electrode mixture prepared by the method described in the above “(I) Method for Preparing Positive Electrode Mixture According to Embodiment”. At this time, the final mixing ratio of positive electrode active material 3, first solid electrolyte 1, and second solid electrolyte 2 was 85:12.9:2.1 in terms of a volume ratio. Therefore, the final mixing ratio of positive electrode active material 3 to the total amount of first solid electrolyte 1 and second solid electrolyte 2 is 85:15 in terms of a volume ratio. In addition, an addition amount of conductive fiber 9 in step S11 was 1.0 wt % with respect to the total amount of positive electrode active material 3, first solid electrolyte 1, and second solid electrolyte 2.

Then, the all-solid-state battery according to Example 1 was manufactured through the negative electrode layer forming step, the solid electrolyte layer forming step, the stacking step, and the pressing step described in the above Method for Manufacturing All-Solid-State Battery.

### (II) Comparative Example 1

An all-solid-state battery according to Comparative Example 1 was prepared in the same method as the all-solid-state battery according to Example 1 described above, except that the positive electrode layer was formed by using the positive electrode mixture prepared by the method described in the above “(II) Method for Preparing Positive Electrode Mixture According to Comparative Example”. At this time, the final mixing ratio of positive electrode active material 3, first solid electrolyte 1, and second solid electrolyte 2 was 85:12.9:2.1 in terms of a volume ratio, as in Example 1. Therefore, the final mixing ratio of positive electrode active material 3 to the total amount of first solid electrolyte 1 and second solid electrolyte 2 is 85:15 in terms of a volume ratio. In addition, an addition amount of conductive fiber 9 in each of step S51 and step S52 was 0.5 wt % with respect to the total amount of positive electrode active material 3, first solid electrolyte 1, and second solid electrolyte 2. That is, an addition ratio of conductive fiber 9 in the positive electrode mixture was the same in Example 1 and Comparative Example 1, and was 1.0 wt %.

Evaluation of Battery Capacity

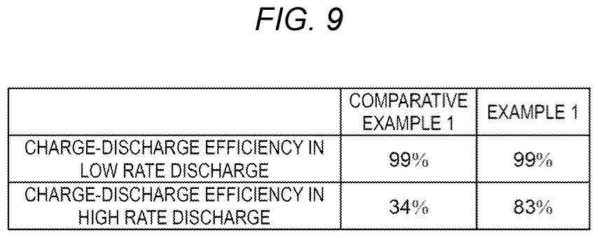

Next, the battery characteristics of the above all-solid-state batteries prepared according to Example 1 and Comparative Example 1 were evaluated. Specifically, FIG. 9 shows results of evaluating charge-discharge efficiency as the battery characteristics serving as an index of the battery capacity. The charge-discharge efficiency was evaluated under two conditions of low rate discharge and high rate discharge. In addition, in the evaluation of the charge-discharge efficiency, charging was performed under conditions of an end voltage of 3.7 V, a current rate of 0.05 C, and a temperature of 25° C. The discharge was performed under conditions of an end voltage of 1.9 V, a current rate of 0.05 C in a case of a low rate, a current rate of 1 C in a case of a high rate, and a temperature of 25° C. In addition, in the evaluation of the charge-discharge efficiency, the charge-discharge efficiency was calculated by starting from charging and calculating a ratio (%) of a discharge capacity to a charge capacity.

As shown in FIG. 9, it can be seen that the charge-discharge efficiency of the all-solid-state battery according to Example 1 is improved as compared with that of the all-solid-state battery according to Comparative Example 1. In particular, the charge-discharge efficiency in the high rate discharge is significantly improved. It is considered that the battery characteristics are improved by intentionally forming fiber-free region 12 on fiber-containing region 13 formed on the surface of positive electrode active material 3. The details will be described below.

In Example 1, by using the positive electrode mixture in which coating layer 11 containing first solid electrolyte 1 and conductive fiber 9 is formed in advance on the surface of positive electrode active material 3, fiber-containing region 13 containing first solid electrolyte 1 and conductive fiber 9 is formed so as to coat the surface of positive electrode active material 3 after the positive electrode layer of the all-solid-state battery is formed. That is, as shown in FIG. 7A, conductive fibers 9 are intensively disposed in the vicinity of the portion X where positive electrode active material 3 is close to or in contact with positive electrode active material 3. Therefore, it is considered that an electrical contact point between positive electrode active materials 3 is easily secured and the conductive path is easily stably formed, and thus the charge-discharge efficiency is improved.

In addition, while conductive fibers 9 are concentrated in the vicinity of the portion X, fiber-free region 12, which is a region free of conductive fiber 9, is formed widely in the gap among positive electrode active materials 3 coated with fiber-containing region 13 in the vicinity of the portion Y shown in FIG. 7A, so that the lithium ion conduction path can be secured. It is considered that the charge-discharge efficiency is improved also by this effect.

The mixing ratio of positive electrode active material 3 to second solid electrolyte 2 in Example 1 and Comparative Example 1 was 85:2.1 in terms of a volume ratio. In the all-solid-state batteries according to Example 1 and Comparative Example 1, a theoretical volume ratio of second solid electrolyte 2 to positive electrode active material 3 is 1/41, and a theoretical volume ratio of second solid electrolyte 2 present in the gap among positive electrode active materials 3 is 1/41. Based on the results of Example 1 and Comparative Example 1, it can be said that in order to secure the lithium ion conduction path, it is important that no conductive fiber 9 is present in a narrow space which is the gap among positive electrode active materials 3.

In the present embodiment, the volume ratio of second solid electrolyte 2 present in the gap among positive electrode active materials 3, that is, fiber-free region 12, to positive electrode active material 3 changes depending on a position due to differences in a particle size distribution and a filling property of positive electrode active material 3. In a case where positive electrode layer 20 is divided into a plurality of regions such that the gaps among positive electrode active material 3 are included in the respective regions, the volume of fiber-free region 12 in each of the plurality of regions is, for example, 1/45 times or more and 2 times or less the volume of positive electrode active material 3. The volume of positive electrode active material 3 may be an average particle volume calculated based on the average particle diameter of positive electrode active material 3. In the case where positive electrode layer 20 is divided into a plurality of regions, for example, positive electrode layer 20 is divided at equal intervals such that a plurality of (for example, 2 or more and 20 or less) particles of positive electrode active material 3 are included in each of the plurality of regions.

When a volume of fiber-free region 12 in each of the plurality of regions is 1/45 times or more the volume of positive electrode active material 3, the lithium ion conduction path can be stably secured, and a sufficient battery capacity can be obtained even in high rate charge and discharge. In addition, when the volume of fiber-free region 12 in each of the plurality of regions is 2 times or less the volume of positive electrode active material 3, the amount of a portion in which the dispersibility of positive electrode active material 3 and second solid electrolyte 2 is poor is partially reduced even when entire positive electrode layer 20 is viewed, the gap among positive electrode active materials 3 does not become too large, positive electrode active material 3 is effectively utilized, so that the battery capacity is improved.

In addition, in Example 1, since conductive fiber 9 is not added when positive electrode active material 3 on which coating layer 11 is formed and second solid electrolyte 2 are mixed, conductive fiber 9 is prevented from being entangled and aggregated with the second solid electrolyte 2. Therefore, the dispersibility of positive electrode active material 3 and second solid electrolyte 2 is improved, and the volume of fiber-free region 12 is easily stably secured in any region in positive electrode layer 20, which is one of the reasons why the effect of improving the battery capacity is obtained.

Examples of one method for controlling the volume of fiber-free region 12 described above include adjustment of the ratio of the total amount of first solid electrolyte 1 and second solid electrolyte 2 to positive electrode active material 3, and adjustment of the ratio of first solid electrolyte 1 to second solid electrolyte 2.

Next, conductive fiber 9 used in the present embodiment will be described. The average fiber diameter of conductive fiber 9 is, for example, 1 nm or more and 30 nm or less. The average fiber length of conductive fiber 9 is 0.1 times or more and 50 times or less the average particle diameter of positive electrode active material 3.

When the average fiber diameter of conductive fiber 9 is 1 nm or more, or the average fiber length of conductive fiber 9 is 0.1 times or more the average particle diameter of positive electrode active material 3, the conductive path between the positive electrode active materials 3 is stably formed, and the battery capacity can be improved. When the average fiber diameter of conductive fiber 9 is 30 nm or less, or the average fiber length of conductive fiber 9 is 50 times or less the average particle diameter of positive electrode active material 3, it is easy to follow a shape of the surface of positive electrode active material 3, fiber-containing region 13 can be stably formed, and the battery capacity can be improved.

### OTHER EMBODIMENTS

As described above, the all-solid-state battery according to the present disclosure has been described based on the embodiments, but the present disclosure is not limited to these embodiments. The embodiments in which a person skilled in the art applies various modifications to the embodiments and other forms that are constructed by combining some of the constituent elements in the embodiments are also included in the scope of the present disclosure as long as they do not depart from the gist of the present disclosure.

For example, in the above embodiment, an example in which ions conducting in all-solid-state battery 100 are lithium ions has been described, but the present disclosure is not limited thereto. The ions conducting in all-solid-state battery 100 may be ions other than the lithium ions such as sodium ions, magnesium ions, potassium ions, calcium ions, and copper ions.

### INDUSTRIAL APPLICABILITY

The all-solid-state battery according to the present disclosure is expected to be applied to various batteries, such as a power source of a mobile electronic device and an in-vehicle battery.

What is claimed is:

1. An all-solid-state battery comprising:
a structure including:
a positive electrode current collector;
a positive electrode layer containing a positive electrode active material, a first solid electrolyte, a second solid electrolyte, and a conductive fiber;
a solid electrolyte layer containing a fourth solid electrolyte;
a negative electrode layer containing a negative electrode active material and a third solid electrolyte; and
a negative electrode current collector,
the positive electrode current collector, the positive electrode layer, the solid electrolyte layer, the negative electrode layer, and the negative electrode current collector being stacked in this order, wherein
the positive electrode layer includes:
a fiber-containing region that coats the positive electrode active material and that contains the conductive fiber and the first solid electrolyte; and
a fiber-free region that is located in a gap surrounded by the positive electrode active material coated by the fiber-containing region, the fiber-free region being free of the conductive fiber, and containing the second solid electrolyte.

2. The all-solid-state battery of claim 1, wherein a material of the first solid electrolyte is identical to a material of the second solid electrolyte.

3. The all-solid-state battery of claim 1, wherein the positive electrode layer includes a plurality of regions, each of the plurality of regions includes the gap, the positive electrode active material, and the fiber-free region, and in each of the plurality of regions, a volume occupied by the fiber-free region is 1/45 times or more and 2 times or less a volume occupied by the positive electrode active material.

4. The all-solid-state battery of claim 1, wherein the fiber-free region continuously extends over the positive electrode layer as a whole in a thickness direction of the positive electrode layer.

5. The all-solid-state battery of claim 1, wherein an average fiber diameter of the conductive fiber is 1 nm or more and 30 nm or less.

6. The all-solid-state battery of claim 1, wherein an average fiber length of the conductive fiber is 0.1 times or more and 50 times or less an average particle diameter of the positive electrode active material.

7. The all-solid-state battery of claim 1, wherein in the positive electrode layer, a volume ratio of the positive electrode active material to a total amount of the first solid electrolyte and the second solid electrolyte is 70:30 or more and 85:15 or less.

8. The all-solid-state battery of claim 1, wherein a solvent component contained in the positive electrode layer is 50 ppm or less.

9. The all-solid-state battery of claim 1, wherein the conductive fiber is a carbon-based material.

10. A method for manufacturing the all-solid-state battery of claim 1, the method comprising:
mixing the positive electrode active material, the first solid electrolyte, and the conductive fiber by a dry method to form a coating layer on the positive electrode active material, the coating layer containing the conductive fiber and the first solid electrolyte; and
mixing the positive electrode active material on which the coating layer is formed and the second solid electrolyte to apply particles free of the conductive fiber and containing the second solid electrolyte to the coating layer.
